(19) United States
(12) Patent Application Publication
(10) Pub. No.: US 2025/0379289 A1
(43) Pub. Date: Dec. 11, 2025

(54) Power Storage Module

(71) Applicant: TOYOTA JIDOSHA KABUSHIKI KAISHA, Toyota-shi Aichi-ken (JP)

(72) Inventor: Hiroaki YAMAMICHI, Takahama-shi Aichi-ken (JP)

(73) Assignee: TOYOTA JIDOSHA KABUSHIKI KAISHA, Toyota-shi Aichi-ken (JP)

(21) Appl. No.: 19/225,459

(22) Filed: Jun. 2, 2025

(30) Foreign Application Priority Data
Jun. 6, 2024 (JP) 2024-092259

(51) Int. Cl. H01M 10/659; H01M 10/613; H01M 10/647; H01M 10/6551; H01M 10/658; H01M 50/209

(52) U.S. Cl. CPC H01M 10/659; H01M 10/613; H01M 10/647; H01M 10/6551; H01M 10/658; H01M 50/209

(57) ABSTRACT

A power storage module includes a plurality of power storage cells stacked together, and includes: a plurality of heat conducting members arranged in contact with the power storage cells so as to be able to conduct heat; a plurality of heat insulating members each thermally insulating two heat conducting members from each other; and a base member arranged in contact with the heat conducting members so as to be able to conduct heat. The power storage cell, the heat conducting member, the heat insulating member, the heat conducting member, and the power storage cell are stacked together in this order. The base member extends in a stacking direction in which the power storage cells, the heat conducting members, and the heat insulating members are stacked together, and is arranged in contact with at least the plurality of heat conducting members so as to be able to conduct heat.

### CROSS REFERENCE TO RELATED APPLICATIONS

This nonprovisional application is based on Japanese Patent Application No. 2024-092259 filed on Jun. 6, 2024 with the Japan Patent Office, the entire contents of which are hereby incorporated by reference.

### BACKGROUND

### Field

The present disclosure relates to a power storage module, and more particularly, to a power storage module in which a plurality of power storage cells are stacked.

### DESCRIPTION OF THE BACKGROUND ART

Conventionally, there has been a battery pack in which battery cells and spacers are alternately stacked (see, for example, Japanese Patent Laying-Open No. 2023-046013). In this battery pack, the spacer is constituted of a heat insulating material and an elastic material. The heat insulating material is resin-coated and is in contact with a heat transfer material under the heat insulating material.

### SUMMARY

In the battery pack of Japanese Patent Laying-Open No. 2023-046013, the spacer is constituted of the heat insulating material and the elastic material. Thus, the spacer is not constituted of a material such as a metal member having a high heat dissipation property. Accordingly, there is a room for improvement in heat dissipation from the battery cell to the heat transfer material.

The present disclosure is made to provide a solution to the above problem, and an object of the present disclosure is to provide a power storage module that enables improvement of heat dissipation from power storage cells.

A power storage module according to the present disclosure is a module including a plurality of power storage cells stacked together, and includes: a plurality of heat conducting members arranged in contact with the power storage cells so as to be able to conduct heat; a plurality of heat insulating members each thermally insulating two of the heat conducting members from each other; and a base member arranged in contact with the heat conducting members so as to be able to conduct heat. The power storage cell, the heat conducting member, the heat insulating member, the heat conducting member, and the power storage cell are stacked together in this order. The base member extends in a stacking direction in which the power storage cells, the heat conducting members, and the heat insulating members are stacked together, and the base member is arranged in contact with at least the plurality of heat conducting members so as to be able to conduct heat.

With such a feature, transfer of heat generated in a power storage cell to an adjacent power storage cell can be suppressed by the heat insulating member. Moreover, heat generated in a power storage cell can be released to the base member through the heat conducting member adjacent to this power storage cell. Accordingly, the power storage module that enables improvement of heat dissipation from the power storage cells can be provided.

The heat insulating members may be formed of resin. With such a feature, the heat insulating property of the heat insulating members can be improved.

The heat conducting members and the base member may be formed of metal. With such a feature, the thermal conductivity of the heat conducting members and the base member can be improved.

The heat conducting members may each include fins. With such a feature, heat dissipation from the heat conducting members can be promoted.

The heat conducting members may be arranged in such a manner that the fins are in contact with the power storage cells so as to be able to conduct heat. With such a feature, heat dissipation from the power storage cells can be promoted.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a structure of a part of a power storage module according to an embodiment of the present disclosure.

FIG. 2 is an exploded perspective view schematically showing a stack structure of power storage cells of the power storage module according to this embodiment.

FIG. 3 is a diagram for explaining heat conduction in the power storage module of this embodiment.

FIG. 4 is a diagram for explaining heat conduction in a power storage module according to a modification of the embodiment.

### DESCRIPTION OF THE EMBODIMENTS

Hereinafter, embodiments of the present disclosure will be described in detail with reference to the drawings. In the drawings, the same or corresponding parts are denoted by the same reference numerals, and the description thereof will not be repeated.

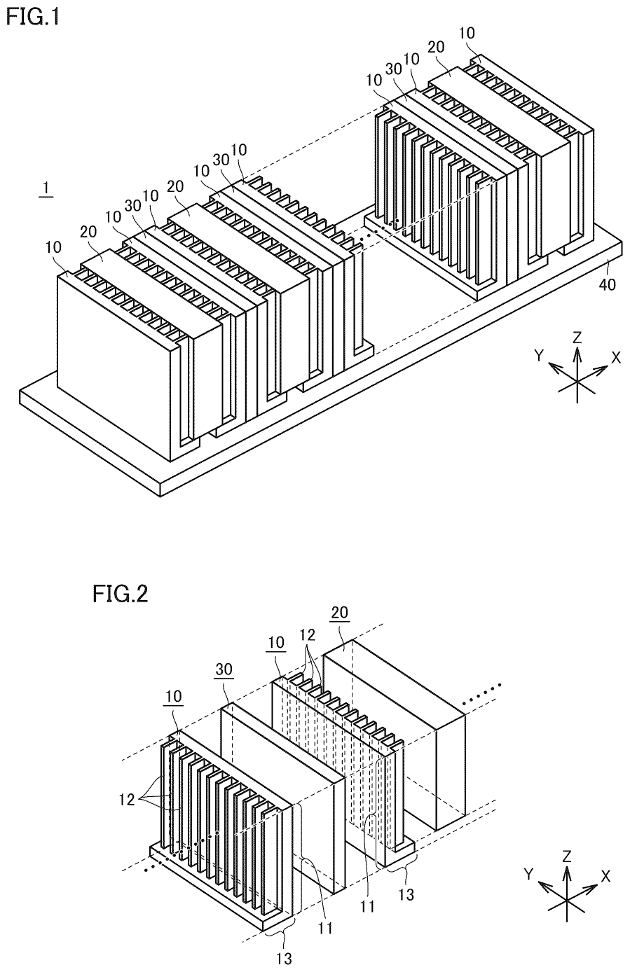

FIG. 1 is a perspective view schematically showing a structure of a part of a power storage module 1 according to an embodiment of the present disclosure. FIG. 2 is an exploded perspective view schematically showing a stack structure of power storage cells 20 of the power storage module 1 according to this embodiment. Referring to FIGS. 1 and 2, the power storage module 1 includes a plurality of power storage cells 20, a plurality of heat conducting members 10, a plurality of heat insulating members 30, and one base member 40. A power storage device is formed by combining a plurality of power storage modules 1. The power storage device may be mounted on a machine such as an electrically powered vehicle or may be stationary.

The power storage cell 20 is a secondary battery, and is, for example, a lithium ion battery. However, the present disclosure is not limited thereto, and the power storage cell 20 may be another type of secondary battery, for example, a nickel-metal hydride battery or an all-solid-state battery. Although not shown in FIGS. 1 and 2, the power storage cell 20 also has other configurations such as a positive electrode terminal and a negative electrode terminal.

The heat insulating member 30 is a member for suppressing transmission of heat generated in the power storage cell 20 to the adjacent power storage cell 20. The heat insulating member 30 is formed of a material having a relatively high heat insulating property, for example, resin. The heat insulating member 30 has a substantially rectangular parallelepiped shape thinner in the X-axis direction relative to the Y-axis direction and the Z-axis direction.

Conventionally, there has been a battery pack in which power storage cells 20 and spacers such as heat insulating members 30 are alternately stacked. In this case, the spacer is not formed of a material such as a metal member having a high heat dissipation property. Therefore, there is a room for improvement in heat dissipation from the power storage cell 20 to a heat transfer material.

Therefore, the power storage module 1 includes a plurality of heat conducting members 10 arranged in contact with the power storage cells 20 so as to be able to conduct heat, a plurality of heat insulating members 30 that thermally insulate two heat conducting members 10 from each other, and a base member 40 arranged in contact with the heat conducting members 10 so as to be able to conduct heat. In the power storage module 1, the power storage cell 20, the heat conducting member 10, the heat insulating member 30, the heat conducting member 10, and the power storage cell 20 are stacked together in this order. The base member 40 extends in the stacking direction (the X-axis direction in the drawing) in which the power storage cells 20, the heat conducting members 10, and the heat insulating members 30 are stacked together, and the base member is arranged in contact with at least the plurality of heat conducting members 10 so as to be able to conduct heat.

Thus, the heat insulating member 30 can suppress transfer of the heat generated in the power storage cell 20 to the adjacent power storage cell 20. In addition, the heat generated in the power storage cell 20 can be released to the base member 40 through the heat conducting member 10 in contact with the power storage cell 20. As a result, heat dissipation from the power storage cell 20 can be improved.

The heat conducting member 10 is a member for transmitting heat generated in the power storage cell 20 to the base member 40 and the heat insulating member 30. The heat conducting member 10 is formed of a material having a relatively high thermal conductivity, for example, metal such as aluminum and copper.

The heat conducting member 10 includes one main body portion 11, one base portion 13, and a plurality of fins 12. In this embodiment, the main body portion 11, the base portion 13, and the fins 12 are integrally molded. However, the present disclosure is not limited thereto, and the main body portion 11, the base portion 13, and the fins 12 may be separately molded and joined by welding or the like so as to be able to conduct heat.

The power storage cell 20 is disposed between the fins 12 of two adjacent heat conducting members 10 so as to be in contact with the tips of the fins 12 on both sides, in a thermally conductive manner. The power storage cell 20 and the fins 12 may be bonded to each other with a thermally conductive adhesive.

The heat insulating member 30 is disposed between respective main body portions 11 of the two heat conducting members 10 so as to be in contact with the main body portions 11. The heat insulating member 30 and the main body portions 11 may be bonded to each other with an adhesive.

The base member 40 is a member for receiving heat transmitted from the heat conducting member 10 and distributing the heat to a wide range other than the heat conducting member, and is formed of a material having a relatively high thermal conductivity, for example, metal such as aluminum and copper.

The base member 40 is disposed in contact with all the base portions 13, in the Z-axis negative direction of the base portions 13, of all the heat conducting members 10. The base member 40 and the base portion 13 may be bonded to each other with a thermally conductive adhesive.

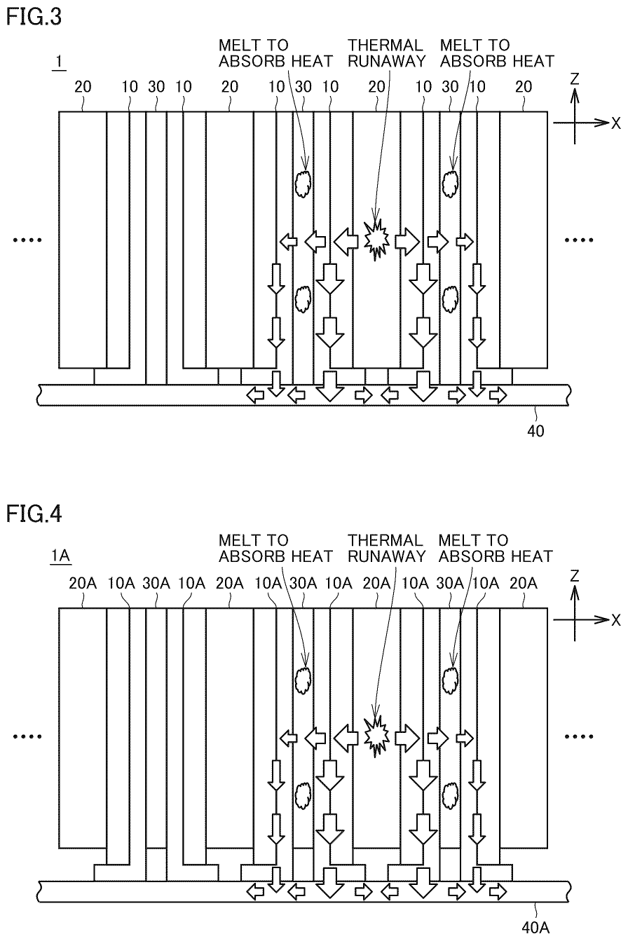

FIG. 3 is a diagram for explaining heat conduction in the power storage module 1 according to the present embodiment. Referring to FIG. 3, in a normal state in which no abnormality occurs in power storage cell 20, heat generated in power storage cell 20 is transmitted to base member 40 via heat conducting member 10 and dispersed. In addition, in a normal state, the heat generated in the power storage cell 20 is also transmitted from the heat conducting member 10 to the heat insulating member 30, but is substantially thermally insulated by the heat insulating member 30 and is not transmitted to other portions. Accordingly, it is possible to improve the cooling performance of the power storage cell 20 in the normal state.

On the other hand, as shown in FIG. 3, in the case of thermal runaway in the power storage cell 20, the heat generated in the power storage cell 20 is transmitted to the base member 40 via the heat conducting member 10, dispersed, and also transmitted from the heat conducting member 10 to the heat insulating member 30 (see the outlined arrow in FIG. 3). Thus, the heat generated in the power storage cell 20 can be efficiently released. The heat transferred to the heat insulating member 30 is insulated to some extent by the heat insulating member 30. However, as shown in FIG. 3, heat that cannot be completely insulated is absorbed by melting a part of the heat insulating member 30. This prevents or suppresses thermal chaining to the adjacent power storage cell 20. In addition, physical contact between the thermal runaway power storage cell 20 and the adjacent power storage cell 20 can be avoided. The heat that has passed through the heat insulating member 30 is transmitted to the base member 40 via the heat conducting member 10 on the opposite side, and is dispersed (see the outlined arrow in FIG. 3). In FIG. 3, the amount of heat transferred is generally indicated by the size of an outlined arrow.

### [Modifications] (1)

FIG. 4 is a diagram for explaining heat conduction in a power storage module 1A according to a modification of this embodiment. Referring to FIG. 4, the shape of power storage module 1A of the modification is different from the shape of power storage module 1 of the above-described embodiment. Specifically, in the above-described embodiment, the power storage cell 20 is in contact with not only the fins 12 of the heat conducting member 10 but also the base portion 13 of the heat conducting member 10. However, in the modification, the power storage cell 20A is in contact with the fins 12 of the heat conducting member 10A, but is not in contact with the base portion 13 of the heat conducting member 10A. In the above-described embodiment, the heat insulating member 30 is in contact with the base member 40. However, in the modification, the heat insulating member 30A is not in contact with the base member 40A.

Even in such a configuration, the same effects as those of the above-described embodiment are exhibited. Specifically, in a normal state in which no abnormality occurs in the power storage cell 20A, the heat generated in the power storage cell 20A is transmitted to the base member 40A via the heat conducting member 10A and dispersed. In addition, in a normal state, the heat generated in the power storage cell 20A is also transmitted from the heat conducting member 10A to the heat insulating member 30A, but is substantially insulated by the heat insulating member 30A and is not transmitted to other portions. Accordingly, the cooling performance of the power storage cell 20A in the normal state can be improved.

On the other hand, as shown in FIG. 4, in the case of thermal runaway in the power storage cell 20A, the heat generated in the power storage cell 20A is transmitted to the base member 40A via the heat conducting member 10A, dispersed, and also transmitted from the heat conducting member 10A to the heat insulating member 30A (see the outlined arrow in FIG. 4). Thus, the heat generated in the power storage cell 20A can be efficiently released. The heat transferred to the heat insulating member 30A is insulated to some extent by the heat insulating member 30A. However, as shown in FIG. 4, heat that cannot be completely insulated is absorbed by melting a part of the heat insulating member 30A. This prevents or suppresses thermal chaining to the adjacent power storage cell 20A. In addition, physical contact between the thermal runaway power storage cell 20A and the adjacent power storage cell 20A can be avoided. The heat that has passed through the heat insulating member 30A is transmitted to the base member 40A via the heat conducting member 10A on the opposite side, and is dispersed (see the outlined arrow in FIG. 4). In FIG. 4, the amount of heat transferred is generally indicated by the size of an outlined arrow.

(2) In the above-described embodiment and modification, the heat conducting members 10 and 10A include the fins 12. However, the present disclosure is not limited thereto, and the heat conducting members 10 and 10A may not include the fins 12. In this case, the main body portions 11 of the heat conducting members 10 and 10A are in direct contact with the power storage cells 20 and 20A, respectively.

(3) In the above-described embodiment, the heat conducting member 10 includes the base portion 13. The base portion 13 may not be provided. In this case, not only the main body portion 11 of the heat conducting member 10 but also the fins 12 may be in direct contact with the base member 40. In the above-described embodiment, the power storage cell 20 is not in contact with the base member 40. However, the present disclosure is not limited thereto, and the power storage cell 20 may be in direct contact with the base member 40.

### SUMMARY

(1) As shown in FIGS. 1 to 4, each of the power storage modules 1, 1A is a module including a plurality of power storage cells 20, 20A that are stacked, and includes a plurality of heat conducting members 10, 10A provided in contact with the power storage cells 20, 20A so as to be able to conduct heat, a plurality of heat insulating members 30, 30A thermally insulating two heat conducting members 10, 10A, and the base member 40, 40A provided in contact with the heat conducting members 10, 10A so as to be able to conduct heat. As illustrated in FIGS. 1 to 4, the power storage cell 20, 20A, the heat conducting member 10, 10A, the heat insulating member 30, 30A, the heat conducting member 10, 10A, and the power storage cell 20, 20A are stacked in this order. As illustrated in FIGS. 1 to 4, the base member 40, 40A extends in the stacking direction in which the power storage cells 20, 20A, the heat conducting members 10, 10A, and the heat insulating members 30, 30A are stacked together, and is provided in contact with at least the plurality of heat conducting members 10, 10A so as to be able to conduct heat.

Accordingly, transfer of the heat generated in the power storage cell 20, 20A to the adjacent power storage cell 20, 20A can be suppressed by the heat insulating member 30, 30A. In addition, the heat generated in the power storage cells 20, 20A can be released to the base member 40, 40A via the heat conducting members 10, 10A in contact with the power storage cells 20, 20A. As a result, heat dissipation from the power storage cells 20, 20A can be improved.

(2) As shown in FIGS. 1 to 4, the heat insulating members 30, 30A may be formed of resin. Accordingly, the heat insulating property of the heat insulating members 30, 30A can be improved.

(3) As illustrated in FIGS. 1 to 4, the heat conducting members 10, 10A and the base member 40, 40A may be formed of metal. Accordingly, it is possible to improve the thermal conductivity of the heat conducting members 10, 10A and the base member 40, 40A.

(4) As shown in FIGS. 1 to 4, the heat conducting members 10, 10A may include fins 12. Accordingly, heat dissipation from the heat conducting members 10, 10A can be promoted.

(5) As illustrated in FIGS. 1 to 4, the heat conducting members 10, 10A may be provided such that the fins 12 are in contact with the power storage cells 20, 20A so as to be able to conduct heat. Thus, heat dissipation from the power storage cells 20, 20A can be promoted.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage module including a plurality of power storage cells stacked together, the power storage module comprising:
a plurality of heat conducting members arranged in contact with the power storage cells so as to be able to conduct heat;
a plurality of heat insulating members each thermally insulating two of the heat conducting members from each other; and
a base member arranged in contact with the heat conducting members so as to be able to conduct heat, wherein
the power storage cell, the heat conducting member, the heat insulating member, the heat conducting member, and the power storage cell are stacked together in this order, and
the base member extends in a stacking direction in which the power storage cells, the heat conducting members, and the heat insulating members are stacked together, and the base member is arranged in contact with at least the plurality of heat conducting members so as to be able to conduct heat.

2. The power storage module according to claim 1, wherein the heat insulating members are formed of resin.

3. The power storage module according to claim 1, wherein the heat conducting members and the base member are formed of metal.

4. The power storage module according to claim 1, wherein the heat conducting members each include fins.

5. The power storage module according to claim 4, wherein the heat conducting members are arranged in such a manner that the fins are in contact with the power storage cells so as to be able to conduct heat.
